(19) United States
(12) Patent Application Publication
(10) Pub. No.: US 2004/0060862 A1
(43) Pub. Date: Apr. 1, 2004

(54) Process for direct filtration of wastewater

(76) Inventors: E. Stuart Savage, (US); David C. Clack, (US)

Correspondence Address: D'AMBROSIO & ASSOCIATES, P.L.L.C., 10260 WESTHEIMER, SUITE 465, HOUSTON, TX, 77042, US

(21) Appl. No.: 10/669,771

(22) Filed: Sep. 24, 2003

Related U.S. Application Data
(63) Continuation-in-part of application No. 09/805,866, filed on Mar. 14, 2001, now abandoned.

(51) Int. Cl. C02F 3/06

(52) U.S. Cl. 210/618; 210/793

(57) ABSTRACT

A process for removing BOD and suspended solids from wastewater without passing through a primary clarifier or secondary aeration tank, the process. During the process, raw sewage wastewater, comprising soluble BOD, insoluble BOD and suspended solids, is piped directly to a deep bed granular filter. The bed depths of deep bed filter are within a range of approximately 2.0 ft to approximately 10.0 ft. The raw sewage wastewater is filtered by filtration through the deep bed filter in which the filter media is a granular media with a size range between approximately 2.0 mm to 10.0 mm. Backwashing the deep bed filter occurs at least once every 48 hours.

### FIELD OF THE INVENTION

The present invention relates to a process for removing BOD and suspended solids from a high volume wastewater stream. More specifically the invention relates to a process for treatment of raw, unsettled wastewater by direct filtration through a deep bed filter without prior treatment in a facultative zone.

### BACKGROUND OF THE INVENTION

The treatment of wastewater, particularly high volume sewage wastewater streams, such as storm surges, typically requires several stages to remove solids as well as soluble and colloidal biological oxygen demand (BOD). The primary treatment stage is a physical process for removing solids. Wastewater containing raw sewage is passed through a clarifier or primary clarifying tank where solids settle out by gravity and form a sludge. After two to four hours in a clarifier, the sludge accumulates at the bottom of the gravity tank. This primary treated effluent floats off the top over weirs and is sent to a secondary treatment tank.

The secondary treatment stage is an aerobic biological process in which the active biomass absorbs the soluble BOD. During this stage, wastewater piped from the clarifier is directed to an aeration tank for the biological treatment required to remove the soluble BOD and colloidal BOD. After this secondary stage, typically a four to twenty-four hour aeration treatment, the wastewater is passed through a secondary clarifier so any remaining solids settle to the bottom as sludge. The sludge is recycled or disposed and the treated wastewater, with solids and soluble BOD removed, can then be disinfected or discharged depending on use of treated water. A tertiary stage for further filtration is used when a better water quality is required.

Attempts have been made to filter the primary effluent coming from the primary clarifier prior to the aeration stage. The problem with adding an expensive filter treatment after the clarifying stage is that filtering the effluent from the primary clarifier is not cost-effective. One reason for the poor economics is that filtering primary effluent removes very little BOD because much of the BOD in the primary effluent is soluble, and therefore, not removed until the secondary or aeration stage. see attached, Cooper-Smith, G. D., and Rundle, H., Primary Effluent Filtration for Coastal Discharges.

Chemical feeds have been used to remove some soluble BOD during the primary or secondary stage. Trickling filter wastewater processes include the step of passing wastewater in a downward flow system in contact with a biomass attached to a fixed-film medium.

Savage, in U.S. Pat. No. 4,179,374, involves a wastewater treatment facility that comprises a facultative zone combined with a columnar oxidation unit. In a facultative zone, BOD is solubilized and rendered non-filterable due to low dissolved oxygen conditions thereby impeding the removal of BOD and suspended solids by filtration.

Molof et al., in U.S. Pat. No. 5,128,040, U.S. Pat. No. 5,651,891, U.S. Pat. No. 5,853,588, and U.S. Pat. No. 5,733,455, disclose a multi-step process for treating wastewater using a “trickling filter” and necessitating at least two settling zones and multiple aerobic, anaerobic and anoxic biological treatment zones for solids separation and reduction of biological oxygen demand. The '040 reference includes the step of passing wastewater containing suspended solids and biodegradable organic materials through an aerobic “biological oxidation zone” and therein oxidizing a portion of the BOD and converting a portion of the BOD into additional suspended solids. Effluent from the aerobic biological oxidation zone is than passed to a mixing zone, several anaerobic and anoxic zones and finally passed to a settling zone. Solids and sludge are sent into an anoxic tank to be recycled through the process. The ‘040’ reference teaches the recycling of biological sludge to an anoxic/anaerobic zone as well as the use of a settling zone to separate purified wastewater having reduced BOD from the suspended solids and sludge.

Molof et al., U.S. Pat. No. 5,651,891 is a continuation of the '040 patent and teaches the use of a volatile acid added to a “zone” in which no additional oxygen has been added. The Molof et al. '455 reference discloses the step of passing a portion of the sludge to an anoxic/anaerobic zone for a time sufficient to produce anoxic/anaerobic-treated solids that include an increased extra-cellular polymer content.

Jonsson, U.S. Pat. No. 5,372,720 teaches a method for reducing nitrogen, phosphorous, and excessive biological oxygen demand (BOD) in wastewater using a granular filter in a single step. In the method disclosed by the '720 reference, the water must have previously been subjected to nitrification as known in the prior art to convert the nitrogen compounds to nitrates and nitrites. The Jonsson ‘720’ method simultaneously precipitates phosphorous, reduces excessive BOD, and performs denitrification. The granular bed is supplied with bacteria oxygen added by blowing an oxygen-containing gas into the filter bed. The ‘720’ reference also teaches the addition of carbon sources to facilitate denitrification.

Dickerson in U.S. Pat. No. 5,788,841 discloses a method of treating wastewater prior to being processed within a wastewater treatment facility. A second Dickerson reference, U.S. Pat. No. 5,578,211 patent teaches a method of reducing undesirable gases in a wastewater collection piping system. Petering in U.S. Pat. No. 5,545,326 discloses a pressurized process for the treatment of high-solids waste water. MacLaren et al., U.S. Pat. No. 5,484,524 teach a wastewater treatment plant comprising three chambers, a pre-treatment chamber for removing solids, a biofilm aeration chamber and a settling chamber.

### SUMMARY OF THE INVENTION

This invention relates to a process for treatment of raw sewage wastewater by direct filtration through a deep bed filter. In this innovative process, both the primary steps of passing the sewage wastewater through a clarifying or settling tank to remove solids or through a facultative zone for denitrification are replaced by the one inventive step of feeding fresh, unsettled sewage directly into a deep bed filter for aerobic filtration. Preferably, the deep bed filter is a granular media filter. During the direct filtration process, suspended solids, soluble BOD and colloidal BOD are removed during filtration. Frequent air/wash backwashing during the process removes entrapped solids and associated BOD.

In one preferred embodiment of the process, the raw sewage can be degritted. In an alternative embodiment, biological floc can be added to the feed wastewater prior to entering the deep bed filter. A sludge stabilization step can also be performed after the sludge stream leaves the filter.

In a preferred embodiment, the process for removing BOD and suspended solids from wastewater takes place without passing through a primary clarifier or secondary aeration tank. During the process, raw sewage wastewater, comprising soluble BOD, insoluble BOD and suspended solids, is piped directly to a deep bed granular filter having bed depths within a range of approximately 2.0 ft to approximately 10.0 ft. Preferably, filtration of raw sewage wastewater takes place in a deep bed filter in which the filter media is a granular media with a size range between approximately 2.0 mm to 10.0 mm. Backwashing the deep bed filter occurs at least once every 48 hours. An additional step of this process can include turning on air backwash so that the filter is bio-conditioned for aerobic activity. The air backwash can be turned on before turning on the water backwash. Alternatively, the air backwash is allowed to continue after the water backwash is turned off so that the filter is bio-conditioned for aerobic activity. In still another alternative, the process includes the additional steps of turning on the air backwash before turning on the water backwash and allowing the air backwash to continue after the water backwash is turned off so that the filter for improved bio-conditioning.

### BRIEF DESCRIPTION OF THE DRAWINGS

FIG. 1 is a schematic of one embodiment of the process of this invention.

FIG. 2 is a flowchart illustrating a process of this invention.

FIG. 3 is a flowchart illustrating another process of this invention.

### DETAILED DESCRIPTION OF INVENTION

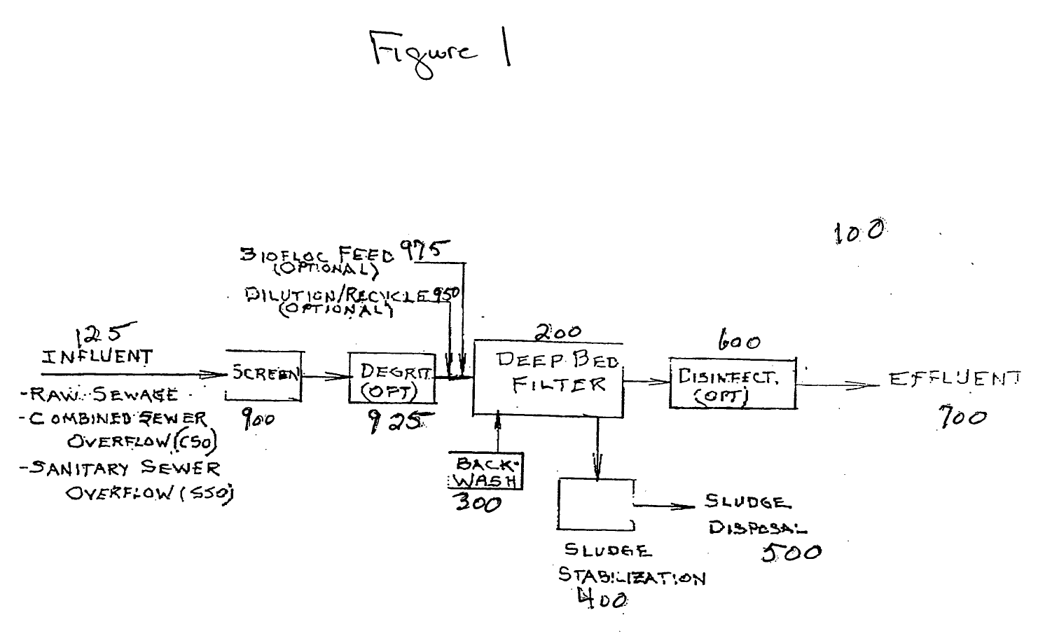

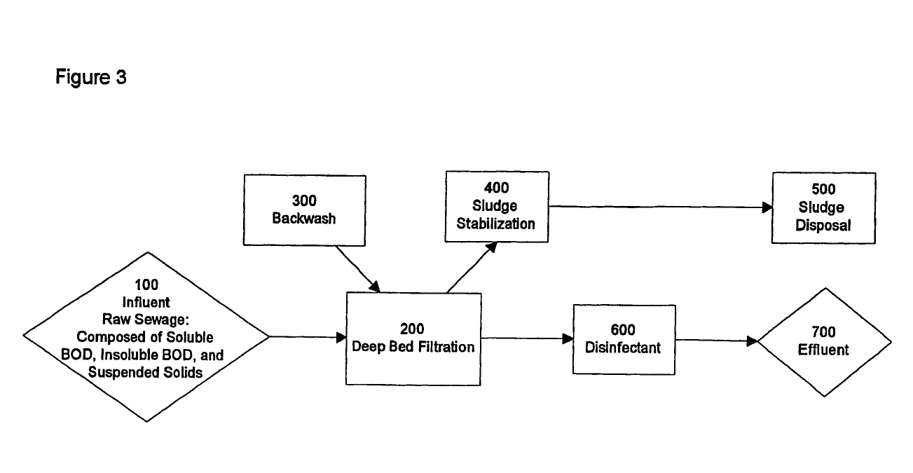

During the process of this invention, a high volume, raw sewage wastewater stream is treated by a direct filtration process in a deep bed filter without the preliminary steps or treatment of passing the wastewater through a clarifying or settling tank to remove solids or through a facultative zone for anaerobic filtration (denitrification). Suspended solids and soluble and colloidal BOD are removed during this single step filtration process. In the direct filtration process, raw sewage wastewater is piped to a deep bed filter without primary clarification or secondary aeration. Referring to FIGS. 1, 2 and 3, one preferred process 100 for removing BOD and suspended solids from wastewater comprises piping influent 125 comprising raw, unsettled wastewater directly to a deep bed filter 200. The raw, unsettled wastewater 125 is then filtered through an aerobic filtration process in a deep bed filter 200. The deep bed filter of this innovative process removes BOD and suspended solids from the raw sewage. During the process, the deep bed filter 200 is backwashed one or more times. The influent 125 can be a combination of raw unsettled sewage, combined sewer overflow (CSO) and sanitary sewer overflow (SSO). Preferably, the raw, unsettled wastewater, SSO and CSO are course screened prior to piping to the deep bed filter 200. Course screening utilizes a bar rack 900 with ½ inch openings between the bars or a wire mesh screen with 6.0 mm openings, to prevent accumulation of debris and waste solids too large to be backwashed from the filter. Fine screening is not required.

In another embodiment of this process, grit is also removed 925 prior to piping the raw, unsettled sewage wastewater to the deep-bed filter. Grit removal 925 utilizes a centrifugal separator or aerated grit chamber to prevent inert, granular material from accumulating within the filter.

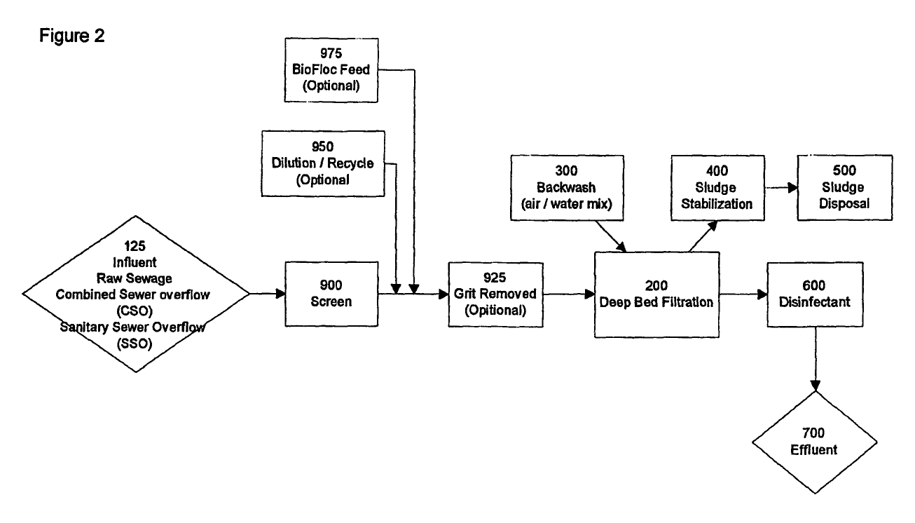

In addition to screening and degritting; the raw, unsettled wastewater can be diluted 950 prior to filtration to increase penetration of suspended solids into the granular media thereby reducing the need for backwashing. Diluting the wastewater also helps to maintain aerobic conditions within the media. It is also advantageous to include a the step of adding biological floc 975, as illustrated in FIG. 2, prior to piping the wastewater to the deep bed filter 200.

The screened and degritted wastewater is piped to a deep bed filter 200. In one alternative embodiment, raw wastewater flows by gravity to the deep bed filter 200. A deep bed filter 200 as used in this process can be supplied by Tetra Process Technologies, marketed under the name, TETRA DeepBed™ Filter. The influent 125 piped to the filter 200 typically comprises soluble BOD, insoluble BOD and suspended solids. During the filtration process, the influent 125 is filtered through filter media which can be comprised of sand and gravel. In one preferred embodiment, the filter media is comprised of a layer of sand, approximately two to six feet in depth. The sand is selected for its size, ranging between approximately, 2.0 mm and 6.0 mm, hardness, spericity, and uniformity coefficient. The sand characters allow for efficient air/water backwash without attrition loss, good solids retention, filtration rate capability and long run times. The sand media is supported by a filter media support system comprising approximately five layers of gravel which, in turn, is supported by underdrain blocks. Alternatively, the filter media can be supported by a filter media support plate, the Savage™ porous plate, for example.

Preferably, the deep bed filter 200 is backwashed 300 and bumped periodically. The term “bumped” refers to a method of degassing biological filters. Degassing a biological filter comprises a series of sequential steps that produce a backwash flow to purge the filter media of gas. Microbes are used to remove BOD and pollutants contained in wastewater. Gas is produced as a result of microbiological activity within the filter media such as respiration and denitrification. Ellard, U.S. Pat. No. 5,989,427, incorporated herein in its entirety, describes a preferred method of degassing biological filters. Preferably, the backwash 300 is an air/water backwash.

Backwashes 300 employ reverse (reverse from the flow of filtrate) flows of both air and previously filtered water that is directed back into the bottom of the filter. Bumps use water only. Backwashes 300 scrub excess solids from the filter media while bumps remove gas buildups and loosen accumulated solids in the filter media to help maintain filtration flow. In one embodiment, the rate of air backwash is within a range of between approximately 1 cfm/sq.ft to 10 cfm/sq.ft. A preferred rate of air backwash is approximately 6 cfm/sq.ft. An additional step of this process can include turning on the air backwash, simultaneous with the water backwash, so that the filter is bio-conditioned for aerobic activity. Alternatively, the air backwash can be turned on before turning on the water backwash. In still another alternative process, the additional step comprises allowing the air backwash to continue after the water backwash. In some instances, it is preferred to turn on the air backwash before turning on the water backwash and also allowing the air backwash to continue after the water backwash is turned off so that the filter is properly bio-conditioned for aerobic activity.

The rate of water backwash can be within a range of between approximately 3 gpm/sq.ft to 35 gpm/sq.ft. Preferably, the rate of water backwash is approximately 6 gpm/sq.ft. to approximately 8 gpm/sq.ft. The length of time of backwash is allowed to run is preferably within a range of approximately 3 minutes to approximately 40 minutes.

In an alternative embodiment of the process for removing BOD and suspended solids from wastewater without passing through a primary clarifier or aeration tank, the process comprises piping raw sewage wastewater 125 comprising soluble BOD, insoluble BOD and suspended solids directly to a deep bed granular filter 200. The deep bed filter 200 comprises bed depths within a range of approximately 2.0 ft to approximately 10.0 ft. The raw sewage wastewater 125 is filtered through the deep bed filter 200 having filter media comprising granular media with a size range between approximately 2.0 mm to 10.0 mm. Backwashing 300 the deep bed filter at least one time every 48 hours is preferred. The backwash can be an air/water backwash wherein the rate of water backwash is within a range of between approximately 2.5 gpm/sq.ft to 25 gpm/sq.ft. and the rate of air backwash is within a range of between approximately 2 cfm/sq.ft to 8 cfm/sq.ft. The preferred length of time of the backwash is within a range of approximately 3 minutes to approximately 40 minutes wherein the bed depth is within a range of approximately 4 ft to approximately 6 ft. It has been found that the effective size of the granular media is within a range of approximately 2.0 mm to 6.0 mm. Preferably, the filtration rate is within a range of between approximately 2 gpm/sq.ft. and approximately 10 gpm/sq.ft.

The direct filtration of raw sewage waste water without having to pass the wastewater through a primary clarifier or secondary aeration tank is effective as illustrated by the test results below. It is believed that solid or insoluble BOD is retained within the filter media and absorbs soluble BOD. Also fibrous material retained within the filter helps to remove colloidal BOD. In other words, a self-filtering process occurs in the deep bed filter wherein soluble BOD is absorbed and colloidal BOD is removed along with the suspended solids.

In the final steps of the filtration process, filtered effluent is collected and flows from the filter 100 to a clearwell (not shown) which acts as a reservoir to supply clean backwash water to the filter 100. Excess water is directed to a discharge location. Sludge stabilization 400 can also be performed after the sludge stream leaves the filter and the sludge disposed 500.

### TEST EQUIPMENT

Feed water for the TETRA DeepBed™ Filter pilot plant was raw wastewater from an influent distribution channel, following coarse screening and aerated grit removal. Wastewater flowed by gravity from the channel to an in-ground filter tank. An air-operated feed pump capable of about 190 gpm pumped the raw water from the filter feed tank to the TETRA filter. A diesel-powered compressor supplied compressed air to the feed pump. The feed pump intake was equipped with a trash screen with ¼″ by ½″ openings.

The feed pump flow was directed through a collapsible hose to a section of pipe near the ground level. The pipe section contained a sample tap and a chemical injection tap. The sample tap supplied a small flow of water to an automatic sampler. The flow then traveled through a gate valve for setting flow rate, then an inline mixer, past another sample tap, through a flow meter and up to the top of the pilot plant tank where it was divided and directed to two filter cells through manual influent valves.

The pilot tank consisted of an 8′-0″ diameter by 18′-6″ tall cylindrical tank that was divided into 4 compartments by vertical walls arranged in an “H” pattern. Two of the compartments were nearly square and served as filters, each with 10 square feet of area. The other two compartments were half-elliptical in shape and served as a clearwell and mudwell.

The influent flow to each filter was directed through the influent valve into a downcomer pipe. The water was conducted to just above the filter media surface where the pipe ended in a splash plate. The distance from maximum water level in the filter to the filter media surface was 103 inches. The distance from the media surface to the normal water level in the clearwell was 14 inches. Combined these measures give 117 inches (9.75′) of driving force to overcome piping head loss and dirt load. The filter media in the filters was 6 feet in depth and 2 to 3 mm in size. The sand was selected for it's size, hardness, sphericity, and uniformity coefficient. The sand characteristics allow for efficient air/water backwash without attrition loss, good solids retention, filtration rate capability and long run times.

The filter media was supported by 5 layers of gravel using a reverse gradation pattern for stability. The gravel rested on a steel underdrain.

After traveling through the filter media, gravel, and underdrain, the filtered water was directed into the clearwell through the automatic effluent valve and the filter backwash pump. In the pilot plant each filter had its own backwash pump for piping simplicity. An automatic sampler pulled filtered water samples from the clearwell.

The filters were backwashed and bumped periodically. Backwashes employed reverse flows of both air and filtered water directed into the bottom of the filter. Bumps used water only. Backwashes scrubbed excess solids from the filter media while bumps removed gas buildups and loosened accumulated solids in the filter media to help maintain filtration flow.

These operations were controlled either automatically or manually from a control panel at ground level beside the pilot plant. A PLC controlled the automatic backwash and bump sequences. A timer in the control panel could be set to determine the start times for automatic backwashes and bumps. Either sequence could also be initiated at will by push-button. Each pump and electric valve had its own hand-off-auto switch to allow for manual operations.

A positive displacement air blower was installed next to the pilot plant at ground level to supply air for backwashing the filters. A backwash air pipe ran up the outside wall of the pilot plant and could be directed to either filter through solenoid-operated valves.

Individual backwash pumps in the clearwell directed filtered water backward through the filter being backwashed or bumped. The backwash pumps were controlled to 6 gpm per sq. ft with manual throttling valves.

When either filter would reach high level during backwash, bump, or filtration it would overflow into a common trough emptying into the mudwell. A single high-capacity pump controlled by a level float kept the mudwell pumped down. The mudwell pump discharge was directed to an adjacent primary clarifier.

### TEST PROCEDURES

The following procedures were followed to start up and maintain filtration run:

1. Open pilot plant influent gate valve fully.

2. Set filter influent valves in desired positions.

3. Start plant water flow into feed tank if needed for runs with diluted feed.

4. Adjust influent flow rate with gate valve.

5. Start chemical feed if any.

6. Check filter influent suspended solids with spectrophotometer and adjust dilution water as needed. Repeat solids checks and dilution water adjustments once per hour during run.

7. Check automatic sampler programs and operation. Start collecting 80 ml samples at 15 minute intervals when test conditions appear to be at steady state, 30 to 60 minutes after beginning influent flow.

8. Determine bumping requirements to minimize instances of overflow and adjust automatic start times in control panel timer.

9. Determine backwash requirements by observing overall filter levels and change in level after bumping.

10. Record run times backwashing and bumping frequency and other data collected.

### TEST RESULTS

EXAMPLE NO. 1

[image]

In the first series of tests, when treating raw wastewater by direct filtration at a rate of 5 gpm/sq.ft.

Plant influent BOD, 118 mg/L (average)

Plant influent TSS, 365 mg/L (average)

Primary effluent BOD, 38.5.0 mg/L (average)

Primary effluent TSS, 39.5 mg/L (average)

Removal of BOD,

By Direct Filtration=67.4% (average)

Removal of TSS,

By Direct Filtration=89.2% (average)

EXAMPLE NO. 2

[image]

In the second series of tests, when treating raw wastewater by direct filtration at a rate of 7.5 gpm/sq.ft.

Plant influent BOD, 94.0 mg/L (average)

Plant influent TSS, 308 mg/L (average)

Primary effluent BOD, 20.0 mg/L (average)

Primary effluent TSS, 50.0 mg/L (average)

Removal of BOD,

By Direct Filtration=78.7% (average)

Removal of TSS,

By Direct Filtration=83.8% (average)

EXAMPLE NO. 3

[image]

In the third series of tests, when treating a diluted raw wastewater by direct filtration at a rate of 10 gpm/sq.ft.

Plant influent BOD, 42.8 mg/L (average)

Plant influent TSS, 93.8 mg/L (average)

Primary effluent BOD, 16.4 mg/L (average)

Primary effluent TSS, 10.6 mg/L (average)

Removal of BOD,

By Direct Filtration=61.7% (average)

Removal of TSS,

By Direct Filtration=88.7% (average)

EXAMPLE NO. 4

[image]

In the fourth series of tests, when treating a diluted raw wastewater by direct filtration at a rate of 5 gpm/sq.ft.

Plant influent BOD, 41.5 mg/L (average)

Plant influent TSS, 82.2 mg/L (average)

Primary effluent BOD, 17.5 mg/L (average)

Primary effluent TSS, 6.6 mg/L (average)

Removal of BOD,

By Direct Filtration=57.8% (average)

Removal of TSS,

By Direct Filtration=92.0% (average)

### EXAMPLE NO. 5

### Comparison to Two-Stage Treatment Process

By comparison, an existing secondary treatment plant consisting of coarse screening, aerated grit removal, primary clarification, secondary aeration in fixed-film bio-towers and secondary clarification, while operating at design capacity during the month of June 2000, had the following results.

Plant influent BOD, 222.8 mg/L (average)

Plant influent TSS, 196.4 mg/L (average)

Primary effluent BOD, 163.8 mg/L (average)

Primary effluent TSS, 86.4 mg/L (average)

Removal of BOD,

In primary treatment=38.6% (average)

In primary+secondary treatment=91.9% (average)

Removal of TSS,

In primary treatment-56.0% (average)

In primary+secondary treatment=90.9% (average)

Raw data for the primary and secondary treatment may be found in Appendix A, attached.

The foregoing description is illustrative and explanatory of preferred embodiments of the invention, and variations in the size, shape, materials and other details will become apparent to those skilled in the art. It is intended that all such variations and modifications which fall within the scope or spirit of the appended claims be embraced thereby.

1. A process for removing BOD and suspended solids from a high volume wastewater stream comprising:
piping high volume, raw, unsettled wastewater directly to a deep bed filter without pretreatment in a facultative zone;
filtering the high volume, raw, unsettled wastewater by filtration through the deep bed filter;
backwashing the deep bed filter.

2. The process of claim 1 wherein the raw, unsettled wastewater is screened prior to piping to the deep bed filter.

3. The process of claim 1 wherein grit is removed prior to piping the raw, unsettled sewage wastewater to the deep bed filter.

4. The process of claim 1 wherein the raw unsettled wastewater is diluted prior to filtration.

5. The process of claim 1 wherein the backwash is an air/water backwash.

6. The process of claim 5 wherein the rate of air backwash is within a range of between approximately 1 cfm/sq.ft to 10 cfm/sq.ft.

7. The process of claim 5 wherein the rate of air backwash is approximately 6 cfm/sq.ft.

8. The process of claim 5 comprising the additional step of turning on the air backwash so that the filter is bio-conditioned for aerobic activity.

9. The process of claim 5 comprising the additional step of turning on the air backwash before turning on the water backwash so that the filter is bio-conditioned for aerobic activity.

10. The process of claim 5 comprising the additional step of allowing the air backwash to continue after the water backwash is turned off so that the filter is bio-conditioned for aerobic activity.

11. The process of claim 5 comprising the additional steps of turning on the air backwash before turning on the water backwash and allowing the air backwash to continue after the water backwash is turned off so that the filter is bio-conditioned for aerobic activity.

12. The process of claim 5 wherein the rate of water backwash is within a range of between approximately 3 gpm/sq.ft to 35 gpm/sq.ft.

13. The process of claim 5 wherein the rate of water backwash is approximately 6 gpm/sq.ft. to approximately 8 gpm/sq.ft.

14. The process of claim 5 wherein the length of time of the backwash is within a range of approximately 3 minutes to approximately 40 minutes.

15. The process of claim 1 further comprising the step of adding biological floc.

16. A process for removing BOD and suspended solids from a high volume wastewater stream without passing through a primary clarifier or secondary aeration tank, the process comprising:
piping the high volume, raw sewage wastewater stream comprising soluble BOD, insoluble BOD and suspended solids directly to a deep bed granular filter comprising a filtration zone but no facultative zone, the deep bed filter further comprising bed depths within a range of approximately 2.0 ft to approximately 10.0 ft.
filtering the raw sewage wastewater by filtration through the deep bed filter, the filter media comprising granular media with a size range between approximately 2.0 mm to 10.0 mm;
backwashing the deep bed filter at least one time every 48 hours.

17. The process of claims 16 wherein the backwash is an air/water backwash.

18. The process of claim 16 wherein the rate of water backwash is within a range of between approximately 2.5 gpmm/sq.ft to 25 gpm/sq.ft.

19. The process of claim 16 wherein the rate of air backwash is within a range of between approximately 2 cfm/sq.ft to 8 cfm/sq.ft

20. The process of claim 16 wherein the time of the backwash run is within a range of approximately 3 minutes to approximately 40 minutes.

21. The process of claim 16 wherein the bed depth is within a range of approximately 4 ft to approximately 6 ft.

22. The process of claim 16 wherein the effective size of the granular media is within a range of approximately 2.0 mm to 6.0 mm.

23. The process of claim 16 wherein the filtration rate is within a range of between approximately 2 gpm/sq.ft. and approximately 10 gpm/sq.ft.
